(19) United States
(12) Patent Application Publication
(10) Pub. No.: US 2018/0073650 A1
(43) Pub. Date: Mar. 15, 2018

(54) SLIDE PLATE VALVE

(71) Applicant: BEIJING POWERTECH TECHNOLOGY CO., LTD., Beijing (CN)

(72) Inventor: YANG LIU, BEIJING (CN)

(21) Appl. No.: 15/815,581

(22) Filed: Nov. 16, 2017

Related U.S. Application Data
(63) Continuation of application No. PCT/CN2016/083096, filed on May 24, 2016.

(30) Foreign Application Priority Data
May 25, 2015 (CN) 201510271795.4

(51) Int. Cl. F16K 17/04; F16K 3/18; F16K 3/314

(52) U.S. Cl. CPC F16K 17/046; F16K 1/2266; F16K 3/314; F16K 3/18

(57) ABSTRACT

Provided is a slide plate valve, comprising a valve body and a valve core component comprising a valve plate (3) and a support frame (2), wherein at least one support member (4) is disposed on the top portion of the support frame (2) and sleeved with an elastic member (7) thereon, and one end of the elastic member (7) is connected to a pressing plate (5) disposed on a top end of the support member (4), and the other end of the elastic member (7) is connected to a limiting plate (6) slidably disposed on the support member. The slide plate valve avoids the problem of getting stuck.

### CROSS-REFERENCE TO RELATED APPLICATIONS

This application is a continuation of International Application No. PCT/CN2016/083096, filed on May 24, 2016, which claims the priority benefit of China Patent Application No. 201510271795.4, filed on May 25, 2015. The contents of the above identified applications are incorporated herein by reference in their entireties.

### TECHNICAL FIELD

The present invention relates to the field of gate valve technology, and particularly to a slide plate valve.

### BACKGROUND

Slide plate valves are widely used in a pipeline system or a vacuum furnace equipment of chemical, mechanical, metallurgical and other industries, and mainly play a role in sealing. Sealing effect of a slide plate valve is of vital importance to the normal operation of the slide plate valve itself or even the overall equipment. For example, in a vacuum coating apparatus, the coating process must be carried out under a vacuum environment, so the slide plate valve must be tightly closed to produce an excellent coated work piece.

At present, the main structure of a slide plate valve includes a valve body and a valve core component, the valve core component includes a support frame, a valve plate and a steel ball fixed on the support frame. The valve plate has a groove capable of receiving the steel ball, and the upper end of the support frame is connected with a cylinder. When the slide plate valve is closed, the cylinder pushes the support frame to move, and the steel ball fixed on the support frame drives the valve plate to move. When the valve plate passes through the space to be sealed and runs to the bottom of the valve body, the valve plate stops moving while the support frame continues moving to remove the steel ball out from the groove and open the valve plate, so that the valve plate is tightly abutted on the valve body, thereby sealing of the space to be sealed by the plate valve is realized. When the slide plate valve is opened, the cylinder draws air out to dive the support frame to move reversely, and at the same time the support frame drives, via the steel ball, the valve plate to move reversely, but because of a larger friction between the steel ball and the valve plate, the steel ball is difficult to return to the groove, leading to the valve plate being stuck and a sealing ring on the outer side of the valve plate is easily damaged and, thus, affecting the sealing effect of the sealing ring when the slide plate valve is opened again.

### SUMMARY

The present invention provides a slide plate valve, avoiding the problem that the slide plate valve is stuck and ensuring continuous and stable operation of the slide plate valve.

The present invention provides a slide plate valve comprising a valve body and a valve core component slidably disposed in the valve body, wherein the valve core component comprises a valve plate and a support frame provided inside the valve plate, one end of the support frame is connected to a driving device, and the support frame is coupled to the valve plate by clamping a steel ball fixedly arranged on the support frame into a corresponding groove of the valve plate, and wherein:

at least one support member is disposed on top portion of the support frame and sleeved with an elastic member thereon, and one end of the elastic member is connected to a pressing plate disposed on top end of the support member, and the other end thereof is connected to a limiting plate slidably disposed on the support member;

wherein the limiting plate abuts against a top end of the valve plate when the driving device drives the support frame to move toward a bottom end of the valve body so that the elastic member is in a compressed state during movement of the support frame toward the bottom end of the valve body, and the elastic member in the compressed state exerts a force on the valve plate through the limiting plate when the support frame moves toward a top end of the valve body so that the valve plate is in a stationary state before the steel ball on the support frame returns to the groove.

In a specific embodiment of the present invention, the number of the support member is one.

In a specific embodiment of the present invention, the support member is a support rod, a top portion of the support rod is fixedly connected to the pressing plate, a bottom portion of the support rod is fixedly connected to the top portion of the support frame, and an outer side of the support rod is sleeved with the limiting plate.

In a specific embodiment of the present invention, a driving rod is provided between the driving device and the support frame to drive the support frame to move under an action of the driving device.

In a specific embodiment of the present invention, there is a plurality of support members.

In a specific embodiment of the present invention, the plurality of support members are a plurality of corresponding support rods, the plurality of support rods are uniformly distributed on the top portion of the support frame, top portion of each of the support rods is provided with one pressing plate, bottom portion of the support rod is fixedly connected with the top portion of the support frame, and the outer side of the support rod is sleeved with the limiting plate.

According to the slide plate valve provided in the embodiment of the present invention, at least one support member is arranged at the upper portion of the support frame, the pressing plate is arranged at the upper portion of the support member, and the limiting plate capable of sliding up and down along the support member is arranged at the lower portion of the support member, an elastic member deformed along the direction of movement of the support member is provided between the pressing plate and the limiting plate. Thus, when the valve plate is closed, the driving device drives the support frame to move, and meanwhile the support frame drives the valve plate to move toward the space to be sealed. When the valve plate moves to the bottom portion of the valve body and touches the valve body, the valve plate stops moving. At this time, the limiting plate abuts against the valve plate; and the driving device drives the support frame to continue moving, and extrudes the steel ball, which is located in the groove and fixed on the support frame, out of the groove. Meanwhile, the support frame drives the support member that is fixed to the top portion of the support frame to move together, so that the elastic member is in a compressed state, the steel extruded from the groove opens the valve plates at both sides, so that the valve plates at both sides are tightly attached to the valve body, to achieve sealing effect. When the valve plate is opened, the driving device drives the support frame to reversely move, and the steel ball fixed on the support frame reversely moves with the movement of the support frame so that the steel ball returns to the groove of the valve plate. At the same time, when the support frame drives the support member to reversely move, since the elastic member is still in the compressed state at this time, the elastic member in the compressed state exerts pressure on the valve plate by the limiting plate that abuts against the valve plate, which prevents movement of the valve plate in advance before the steel ball returns to the groove. In this case the steel ball returns to the groove under the driving of the support frame, and when the steel ball returns to the groove of the valve plate, the valve plates at both sides are automatically retracted and tightly attached to the support frame. Meanwhile, the support frame continues reverse movement under the driving of the driving device, and drives the valve plate to move reversely by the steel ball returned to the groove, so that the valve plate moves in a direction away from the space to be sealed. When the valve plate completely leaves the space to be sealed, the opening process of the valve plate is completed. Therefore, the slide plate valve provided by the present invention can ensure that the steel ball on the support frame can smoothly returns to the groove on the valve plate, thereby avoiding the problem of the slide plate valve getting stuck, and ensuring continuous and stable operation of the slide plate valve. At the same time, the valve plate does not move until the steel ball returns to the groove, which avoids wear of the sealing ring on the valve plate, thereby enhancing sealing effect and prolonging service life of the sealing ring.

### BRIEF DESCRIPTION OF DRAWINGS

In order to more clearly illustrate the embodiments of the present invention or the technical solutions in the prior art, the drawings, which are to be used in the description of the embodiments or the prior art, will be briefly described below. It is obvious that the drawings described below are some of the embodiments of the present invention, and other drawings may be obtained by those of ordinary skill in the art without creative efforts.

FIG. 1 is a structure schematic view of a slide plate valve provided in a first embodiment of the present invention; and

FIG. 2 is a structure schematic view of a slide plate valve provided in a second embodiment of the present invention.

Description of reference numbers are as follows:
1—13 driving device; 2—13 support frame; 3—13 valve plate; 4—13 support member; 5—13 pressing plate; 6—limiting plate; 7—13 elastic member; 8—13 steel ball; 9—13 space to be sealed; 10—13 driving rod.

### DESCRIPTION OF EMBODIMENTS

In order to make purposes, technical solutions and advantages of the embodiment of the present invention more clear, the embodiment of the present invention will be clearly and completely described in the following with reference to the accompanying drawings. Obviously, the embodiments described are only a part of the embodiments of the present invention, but not all of the embodiments. Based on the embodiments of the present invention, all other embodiments obtained by those of ordinary skill in the art without creative efforts, belong to the protection scope of the present invention.

In order to clearly and accurately understand the technical solution of the present invention, the terms in the application documents of the present invention are defined as follows: as used herein, the lower portion is near the bottom of the valve body in the direction of movement of the support frame, the upper portion is away from the bottom of the valve body, the bottom portion is the end toward the bottom of the valve body, and the top portion is the end away from the bottom of the valve body.

### Embodiment 1

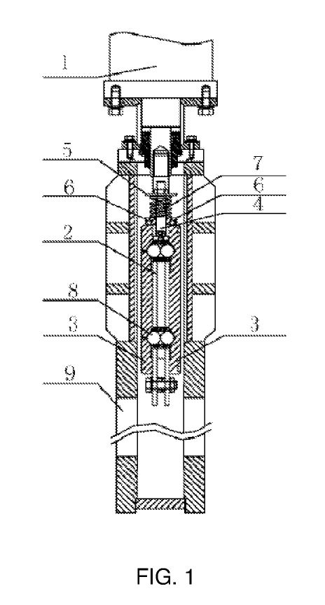

FIG. 1 is a structure schematic view of a slide plate valve provided in the first embodiment of the present invention, as shown in FIG. 1:

The slide plate valve provided in the embodiment comprises a valve body and a valve core component, wherein the valve core component is slidably arranged in the valve body, and comprises a valve plate 3 and a support frame 2 provided in the valve plate 3, one end (specifically, top end) of the support frame 2 is connected to a driving device 1, wherein a steel ball 8 is fixedly arranged on the support frame 2, a groove matched with the steel ball 8 is formed in the inner surface of the valve plate 3, the support frame 2 and the valve plate 3 are connected by clamping the steel ball 8 into the groove. It should be noted that during the driving device 1 driving the support frame 2 to move, the steel ball 8 on the support frame 2 is extruded from the groove when the valve plate 3 is stopped by the bottom end of the valve body from moving.

In order to achieve the successful return of the steel ball 8, which is extruded from the groove, to the groove, in the embodiment, at least one support member 4 is arranged at the top portion of the support frame 2. The support member 4 extends in the direction of movement of the support frame 2, the support member 4 is sleeved with an elastic member 7 thereon, and one end of the elastic member 7 is connected to a pressing plate 5 disposed on the top end of the support member 4, and the other end of the elastic member 7 is connected to a limiting plate 6 slidably disposed on the support member 4, that is, as shown in FIG. 1, the pressing plate 5 is arranged at the top end of the support member 4, the limiting plate 6 capable of sliding up and down along the support member 4 is arranged at the bottom end of the support member 4, the elastic member 7, which is deformed in the movement direction of the support member 4, is arranged between the pressing plate 5 and the limiting plate 6, wherein the limiting plate 6 abuts against the top end of the valve plate 3 when the driving device 1 drives the support frame 2 to move toward the bottom end of the valve body so that the elastic member 7 is in a compressed state during the movement of the support frame 2 toward the bottom end of the valve body, and the elastic member 7 in the compressed state exerts a force on the valve plate 3 by the limiting plate 6 when the support frame 2 moves toward the top end of the valve body so that the valve plate 3 is in a stationary state before the steel ball 8 on the support frame 2 returns to the groove.

In order to clearly and accurately understand the structure of the present invention, a specific working process of the slide plate valve provided in the embodiment is described as follows.

When the valve plate 3 is closed, gas is introduced into a driving cylinder of the drive device 1; the driving device 1 drives the support frame 2 to move; meanwhile, since the support frame 2 is connected with the valve plate 3 by clamping the steel ball 8 into the groove, the support frame 2 during movement will drive the valve plate 3 to move toward a space to be sealed 9, and the support member 4 located on the support frame 2 moves downward during movement of the support frame 2. When the valve plate 3 moves to the bottom portion of the valve body and touches the valve body, the valve plate 3 stops moving, and at this time, the limiting plate 6 abuts against the top end of the valve plate 3. The driving device 1 drives the support frame 2 to continue moving. Since the valve plate 3 stops moving, the steel balls 8 in the groove of the valve plate 3 is extruded from the groove as the support frame 2 moves, and the extruded steel ball 8 opens valve plates 3 at both sides open, and thus the valve plates 3 at both sides are tightly attached to the valve body to achieve a good sealing effect. At the same time, during the movement of the support frame 2, the support frame 2 drives the support member 4 which is fixed to the top portion of the support frame 2 to move in the same direction. The limiting plate 6 is in a stationary state due to abutting against the valve plate 3, and the pressing plate 5 provided at the top end of the support member 4 presses the elastic member 7 with the movement of the support member 4 so that the elastic member 7 is in a compressed state.

When the valve plate 3 is opened, gas is reversely introduced into the drive cylinder of the driving device 1, and the driving device 1 drives the support frame 2 to reversely move. The steel ball 8 fixed to the support frame 2 reversely moves with movement of the support frame 2. Since the elastic member 7 is still in a compressed state at this time, the elastic member 7 in the compressed state exerts a pressure on the valve plate 3 by the limiting plate 6 abutting against the valve plate 3 to prevent movement of the valve plate 3 before the steel ball 8 returns to the groove. That is, when the support frame 2 starts moving upward, the valve plate 3 is in a stationary state under limiting function of the limiting plate 6 (i.e., the valve plate 3 does not move upward with movement of the support frame 2). When the support frame 2 moves upward to make the steel ball 8 return to the groove of the valve plate 3, the valve plates 3 at both sides are automatically retracted and tightly attached to the support frame 2. The support frame 2 continues reverse movement under drive of the driving device 1 and drives the valve plate 3 to reversely move by the steel ball 8 which is returned to the groove so that the valve plate 3 moves in a direction away from the space to be sealed 9. When the valve plate 3 completely leaves the space to be sealed 9, the opening of the valve plate 3 is completed.

In this embodiment, the presence of the elastic member 7 avoid that the valve plate 3 moves in advance when the valve plate 3 is opened, the steel ball 8 cannot properly return to the groove and thus slide plate valve is stuck; and meanwhile it also avoid that the steel ball 8 presses the valve plate 3 before the steel ball 8 returns to the groove so that the valve plate 3 is tightly attached to the valve body to move, thereby causing damage to the sealing ring on the outside of the valve plate 3. The slide plate valve provided in this embodiment ensures the normal opening of the slide plate valve and enhances the sealing effect of the sealing ring to ensure the normal movement of the slide plate valve and prolong the service life of the slide plate valve.

### Embodiment 2

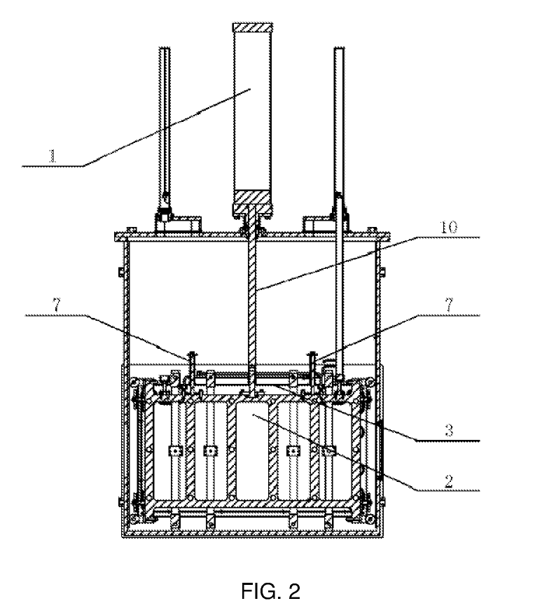

FIG. 2 is a schematic view of the structure of a slide plate valve provided in the second embodiment of the present invention. The present embodiment is based on the above embodiment. As shown in FIG. 1-2, the slide plate valve comprises a valve body and a valve core component, wherein the valve core component comprises a support frame 2 and a valve plate 3 that are connected with the driving device 1. At less one support member 4 is disposed on the upper portion of the support frame 2, the support member 4 extends in the movement direction of the support frame 2, and a pressing plate 5 is arranged at the upper portion of the support member 4, a limiting plate 6 capable of sliding up and down along the support member 4 is arranged at the lower portion of the support member 4, and an elastic member 7 is arranged between the pressing plate 5 and the limiting plate 6 and deformed along the movement direction of the support member 4. When the valve plate 3 is closed, the limiting plate 6 abuts against the valve plate 3, and the pressing plate 5 and the limiting plate 6 are cooperated with each other so that the elastic member 7 is in a compressed state.

Wherein the support member 4 may be one or more, and in the present embodiment, one implementation form is: when the support member 4 is one, the support member 4 may be a support rod, the upper portion of the support rod is fixed to the pressing plate 5, the bottom portion of the support rod is fixed to the top portion of the support frame 2, and the pressing plate 6 is sleeved on the outside of the support rod. When the valve plate 3 is closed, the limiting plate 6 abuts against the valve plate 3, and the pressing plate 5 cooperates with the limiting plate 6 so that the elastic member 7 is in a compressed state. When the valve plate 3 is opened, the elastic member 7 in the compressed state applies pressure to the valve plate 3 to prevent the valve plate 3 from movement in advance before the steel ball 8 returns to the groove and ensures that the steel ball 8 correctly returns to the groove, thereby ensuring the normal opening of the valve plate 3. The closing and opening process of the slide plate valve is substantially the same as that described in the first embodiment and will not be described here.

One implementation form of this embodiment is: when the support member 4 is one, as shown in FIG. 2, a driving rod 10 is arranged between the driving device 1 and the support frame 2, the driving rod 10 is used for driving the support frame 2 to move under the action of the driving device 1.

One implementation form of this embodiment is: when there is a plurality of support members 4, the plurality of support members may be a plurality of corresponding support rods and the plurality of support rods are evenly distributed on the support frame 2 so that force exerted on the support frame 2 by the support rods is uniform, and the service life of the slide plate valve is prolonged. The working process is substantially the same as that described in the first embodiment, except that there is a plurality of support members and the plurality of support members are a plurality of corresponding support rods, the upper portion of each of the support rods is provided with one pressing plate 5, the lower portion of each of the support rods is provided with a limiting plate 6 which is slidable up and down along the support rod, an elastic member 7 capable of deforming along the movement direction of the support rod is arranged between the pressing plate 5 and the limiting plate 6. When the valve plate 3 is closed, each limiting plate 6 abuts against the valve plate 3, and each pressure plate 5 cooperates with corresponding stopper plates 6 so that the corresponding elastic member 7 is in a compressed state. When the valve plate 3 is opened, each elastic member 7 in the compressed state exerts pressure on the valve plate 3 to prevent the valve plate 3 from movement in advance before the steel ball 8 returns to the groove and ensure that the steel ball 8 correctly returns to the groove, thus ensuring the normal opening of the valve plate 3.

Uniform distribution of the support rods on the support frame 2 can avoid the slide plate valve to be stuck and ensure continuous normal operation of the slide plate valve and meanwhile make force of the support rod exerted on the support frame 2 uniform, enhancing the service life of the slide plate valve.

Finally, it should be noted that the above embodiments are merely to illustrate the technical solutions of the present invention and are not intended to limit thereto. Although the present invention has been described in detail with reference to the foregoing embodiments, it will be understood by those of ordinary skill in the art that it is still possible to modify the technical solutions described in the foregoing embodiments or to equivalently replace some or all of the technical features therein, and these modifications or replacements will not make essences of the corresponding technical solutions departing from scope of technical solutions of the embodiments of the present invention.

What is claimed is:

1. A slide plate valve, comprising a valve body and a valve core component slidably disposed in the valve body, wherein the valve core component comprises a valve plate and a support frame provided inside the valve plate, one end of the support frame is connected to a driving device, the support frame is coupled to the valve plate by clamping a steel ball fixed to the support frame into a corresponding groove of the valve plate, wherein:
at less one support member is disposed on a top portion of the support frame and sleeved with an elastic member thereon, and one end of the elastic member is connected to a pressing plate disposed on a top end of the support member, and the other end of the elastic member is connected to a limiting plate slidably disposed on the support member;
wherein the limiting plate abuts against a top end of the valve plate when the driving device drives the support frame to move toward a bottom end of the valve body so that the elastic member is in a compressed state during movement of the support frame toward the bottom end of the valve body, and the elastic member in the compressed state exerts a force on the valve plate through the limiting plate when the support frame moves toward a top end of the valve body so that the valve plate is in a stationary state before the steel ball on the support frame returns to the groove.

2. The slide plate valve according to claim 1, wherein the number of the support member is one.

3. The slide plate valve according to claim 2, wherein the support member is a support rod, a top end of the support rod is fixedly connected to the pressing plate, a bottom end of the support rod is fixedly connected to the top portion of the support frame, and an outer side of the support rod is sleeved with the limiting plate.

4. The slide plate valve according to claim 2, wherein a driving rod is provided between the driving device and the support frame for driving the support frame to move under an action of the driving device.

5. The slide plate valve according to claim 1, wherein there is a plurality of support members.

6. The slide plate valve according to claim 5, wherein the plurality of support members are a plurality of corresponding support rods, the plurality of support rods are uniformly distributed on the top portion of the support frame, top portion of each support rod is provided with one pressing plate, bottom portion of the support rod is fixedly connected to the top portion of the support frame, and an outer side of the support rod is sleeved with the limiting plate.
